(19) United States
(12) Patent Application Publication
(10) Pub. No.: US 2025/0258802 A1
(43) Pub. Date: Aug. 14, 2025

(54) EFFICIENT PROCESSING OF TRIE DATA STRUCTURES TO SUPPORT CUSTOMER JOURNEY VISUALIZATIONS

(71) Applicant: Genesys Cloud Services, Inc., Menlo Park, CA (US)

(72) Inventors: Ameen Oladehinde-Bello, Galway (IE); Colm John Hally, Galway (IE); Maud D. McEvoy, Galway (IE); Ankit Pat, Toronto (CA); Peter Roche, Galway (IE); Aditi Shah, Menlo Park, CA (US)

(21) Appl. No.: 19/051,099

(22) Filed: Feb. 11, 2025

Related U.S. Application Data
(60) Provisional application No. 63/552,886, filed on Feb. 13, 2024.

(51) Int. Cl. G06F 16/21

(52) U.S. Cl. CPC G06F 16/211

(57) ABSTRACT

A method for providing efficient trie data structure processing according to an embodiment includes splitting, based on organization identifiers and sequence identifiers, a data frame indicative of a set of events associated with customer interactions with automated agents of a contact center to produce a set of multiple partitions, and producing a set of multiple trie data structures, including generating a trie data structure for each partition. Each trie data structure represents aggregate counts of a corresponding subset of event sequences associated with a corresponding organization. The method also includes merging multiple trie data structures of the set of trie data structures to produce a combined organization trie data structure and storing the combined organization trie data structure to enable generation of a visualization of the combined organization trie data structure.

### CROSS-REFERENCE TO RELATED APPLICATIONS

This application claims priority to and the benefit of U.S. Provisional Application No. 63/552,886, titled “ENHANCED GENERATION OF CUSTOMER JOURNEY VISUALIZATIONS VIA USE OF TRIE DATA STRUCTURES,” filed on Feb. 13, 2024, the contents of which are incorporated herein by reference in their entirety.

### BACKGROUND

A customer of a product or service provided by an organization may contact a call center or contact center associated with an organization to obtain support related to the product or service. In doing so, the customer may interact with human and/or virtual agents via electronic communications through technologies including, for example, telephone, email, web chat, Short Message Service (SMS), dedicated software application(s), and/or other technologies. In many scenarios, a customer may be routed among multiple agents as the communication progresses and the type of support and/or the particular agent best suited to provide the requested support is determined.

### SUMMARY

One embodiment is directed to a unique system, components, and methods for providing efficient trie data structure processing to support customer journey visualizations. Other embodiments are directed to apparatuses, systems, devices, hardware, methods, and combinations thereof for providing efficient trie data structure processing to support customer journey visualizations.

According to an embodiment, a method for providing efficient trie data structure processing may include splitting, by a computing system and based on organization identifiers and sequence identifiers, a data frame indicative of a set of events associated with customer interactions with automated agents of a contact center to produce a set of multiple partitions. The method may also include producing, by the computing system, a set of multiple trie data structures, including generating a trie data structure for each partition. Each trie data structure may represent aggregate counts of a corresponding subset of event sequences associated with a corresponding organization. The method may also include merging, by the computing system, multiple trie data structures of the set of trie data structures to produce a combined organization trie data structure and storing, by the computing system, the combined organization trie data structure to enable generation of a visualization of the combined organization trie data structure.

In some embodiments, the method may also include assigning, by the computing system, each partition to a separate execution unit for concurrent processing.

In some embodiments, the method may also include performing, by the computing system, analytics on the combined organization trie data structure including filtering the combined organization trie data structure as a function of a path category indicative of a type of event that occurred during the customer interactions with the automated agents of the contact center.

In some embodiments, merging the multiple trie data structures may include identifying a set of unique organization identifiers associated with the multiple trie data structures, repartitioning the data frame based on the organization identifiers and merging trie data structures that are associated with a shared organization identifier.

In some embodiments, merging the multiple trie data structures may include initializing an empty base trie data structure, reading multiple trie data structures of the set from storage as subtrie data structures, and merging each subtrie data structure into the base trie data structure.

In some embodiments, merging each subtrie data structure into the base trie data structure may include, for each subtrie data structure, sorting node paths by distance from a root in ascending order and combining a subtrie node with a base trie node in response to a determination that a node path exists in the base trie data structure or adding the subtrie node to the base trie data structure as a new node in response to a determination that the node path does not exist in the base trie data structure.

In some embodiments, the method may further include tracking, by the computing system, merged nodes of the combined organization trie data structure using a node map and calculating, by the computing system, an edge count for a selected node represented in the node map, including querying the node map to identify the set of merged nodes and summing individual counts associated with the merged nodes.

In some embodiments, the method may further include identifying, by the computing system, a selected node of the combined organization trie data structure for a drilled-down view in the visualization, identifying, by the computing system, a child node set of one or more child nodes of the selected node, and deleting, by the computing system, the child node set from the visualization.

In some embodiments, the method may also include identifying a parent node set of one or more parent nodes of the selected node, identifying a set of one or more child nodes of the parent node set, subtracting counts of the identified child nodes from counts of corresponding parent nodes in the parent node set to provide an accurate representation of count data pertaining to the drilled-down view, and deleting the identified child nodes of the parent node set in the drilled-down view.

According to another embodiment, a system for providing efficient trie data structure processing may include at least one processor and at least one memory comprising a plurality of instructions stored thereon that, in response to execution by the at least one processor, may cause the system to split, based on organization identifiers and sequence identifiers, a data frame indicative of a set of events associated with customer interactions with automated agents of a contact center to produce a set of multiple partitions and produce a set of multiple trie data structures, including generating a trie data structure for each partition. Each trie data structure may represent aggregate counts of a corresponding subset of event sequences associated with a corresponding organization. The plurality of instructions may additionally cause the system to merge multiple trie data structures of the set of trie data structures to produce a combined organization trie data structure and store the combined organization trie data structure to enable generation of a visualization of the combined organization trie data structure.

In some embodiments, the plurality of instructions may further cause the system to assign each partition to a separate execution unit for concurrent processing.

In some embodiments, the plurality of instructions may further cause the system to perform analytics on the combined organization trie data structure including filtering the combined organization trie data structure as a function of a path category indicative of a type of event that occurred during the customer interactions with the automated agents of the contact center.

In some embodiments, to merge the multiple trie data structures may include to identify a set of unique organization identifiers associated with the multiple trie data structures, repartition the data frame based on the organization identifiers, and merge trie data structures that are associated with a shared organization identifier.

In some embodiments, to merge the multiple trie data structures comprises to initialize an empty base trie data structure, read multiple trie data structures of the set from storage as subtrie data structures, and merge each subtrie data structure into the base trie data structure.

In some embodiments, to merge each subtrie data structure into the base trie data structure includes, for each subtrie data structure, to sort node paths by distance from a root in ascending order and combine a subtrie node with a base trie node in response to a determination that a node path exists in the base trie data structure or add the subtrie node to the base trie data structure as a new node in response to a determination that the node path does not exist in the base trie data structure.

In some embodiments, the plurality of instructions may further cause the system to track merged nodes of the combined organization trie data structure using a node map and calculate an edge count for a selected node represented in the node map, including querying the node map to identify the set of merged nodes and summing individual counts associated with the merged nodes.

In some embodiments, the plurality of instructions may further cause the system to identify a selected node of the combined organization trie data structure for a drilled-down view in the visualization, identify a child node set of one or more child nodes of the selected node, and delete the child node set from the visualization.

In some embodiments, the plurality of instructions may further cause the system to identify a parent node set of one or more parent nodes of the selected node, identify a set of one or more child nodes of the parent node set, subtract counts of the identified child nodes from counts of corresponding parent nodes in the parent node set to provide an accurate representation of count data pertaining to the drilled-down view, and delete the identified child nodes of the parent node set in the drilled-down view.

According to yet another embodiment, one or more non-transitory machine-readable storage media may include a plurality of instructions stored thereon that, in response to execution by a computing system, may cause the computing system to split, based on organization identifiers and sequence identifiers, a data frame indicative of a set of events associated with customer interactions with automated agents of a contact center to produce a set of multiple partitions and produce a set of multiple trie data structures, including generating a trie data structure for each partition. Each trie data structure may represent aggregate counts of a corresponding subset of event sequences associated with a corresponding organization. The plurality of instructions may also cause the computing system to merge multiple trie data structures of the set of trie data structures to produce a combined organization trie data structure and store the combined organization trie data structure to enable generation of a visualization of the combined organization trie data structure.

In some embodiments, the plurality of instructions may further cause the computing system to assign each partition to a separate execution unit for concurrent processing.

This summary is not intended to identify key or essential features of the claimed subject matter, nor is it intended to be used as an aid in limiting the scope of the claimed subject matter. Further embodiments, forms, features, and aspects of the present application shall become apparent from the descriptions and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 depicts a simplified block diagram of at least one embodiment of a contact center system;

FIG. 2 is a simplified block diagram of at least one embodiment of a computing device;

FIG. 3 is a simplified flow diagram of at least one embodiment of a method for filtering a trie data structure by a specific event;

FIG. 4 is a simplified flow diagram of at least one embodiment a method for filtering a trie data structure by an event attribute;

FIG. 5 is a simplified flow diagram of at least one embodiment of a method for filtering a trie data structure by a bot flow;

FIGS. 6-7 illustrate various states of an example trie data structure being filtered by a specific event;

FIGS. 8-10 illustrate various states of an example trie data structure being filtered by an event attribute;

FIGS. 11-12 illustrate various states of an example trie data structure being filtered by a bot flow;

FIGS. 13-14 are a simplified flow diagram of a method for partitioning data for efficient processing of trie data structures;

FIG. 15 is a simplified flow diagram of a method for merging trie data structures into a combined trie data structure;

FIG. 16 is a simplified flow diagram of a method for calculating accurate edge counts for a node associated with a trie data structure;

FIG. 17 is a simplified flow diagram of a method for calculating accurate count data for a drilled-down view in a visualization of a trie data structure; and

FIGS. 18-19 illustrate different states of a trie data structure associated with a visualization.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

The technologies described herein pertain to customer relations services and customer relations management via contact centers and associated cloud-based systems. More particularly, the technologies described herein enable the generation of user-friendly visualizations that assist customer-experience managers of contact centers to improve the “big picture” experience of customers in their interactions with agents associated with the contact center, including automated agents (“bots”). The visualizations may include, for example, flow milestones and outcomes of interactions. In enabling the generation of visualizations, the illustrative technologies may utilize a trie data structure while providing functionality for filtering, searching, and querying to show events in customers' journeys starting at a particular event, events that include a particular attribute value, and/or events associated with a particular bot flow (e.g., executed by a bot or automated agent of the contact center system). Further, technologies described herein may allow for the efficient processing of trie data structures, including merging such data structures while maintaining data fidelity, to enhance the generation of customer journey visualizations and related analytics. For example, embodiments provided herein include techniques for split processing and merging of tries for relatively large organizations, to provide increased computational efficiency and system reliability. Further embodiments are provided that ensure that counts of inflow and outflow at each node in a trie data structure are equal in a visualization of pathways (e.g., sequences of events represented by the nodes).

Trie data structure implementations traditionally have drawbacks that limit their capabilities in certain use cases. For example, to enable filtering and querying capabilities based on any event and visualizing paths to/from that event, it is possible to simply create multiple trie data structures, with one trie data structure for each event or node within the trie data structure. However, such an approach is computationally intensive and leads to significant scalability issues. Accordingly, the technologies described herein provide for a scalable solution that permits such types of filtering and querying using trie data structures (i.e., without building separate tries for each query event). Further, the technologies described herein allow for an online (e.g., cloud-based) computational approach while maintaining reasonable latency (e.g., latency that satisfies typical service level agreement requirements, such as maximum query responses of one second). Instead of creating a trie for each filtering criterion, a single “big picture” trie may be stored for each organization, which includes each of the bot flows and associated event attributes. This approach significantly reduces the processing and read/write operations required, resulting in improved efficiency. The reduced number of files and their corresponding read/write operations also result in lower operational cost. The system can also seamlessly integrate with various bot flows, allowing for diverse and customizable functionalities.

The technologies provided herein enable efficient processing of event data that forms a basis for producing trie data structures to be represented in a visualization of a customer journey. As described in more detail herein, in at least some embodiments, the efficient processing includes splitting event data in a data frame into multiple partitions, producing trie data structures based on each of those partitions, and selectively merging trie data structures based on the organization associated with each trie data structure. By partitioning the data frame, the technologies described herein enable generation of the corresponding trie data structures in parallel, such as with corresponding execution units (e.g., processing devices), rather than over burdening a single execution unit with the task of generating a trie data structure from a relatively large data frame. Additionally, embodiments of the technology described in more herein enable operations to accurately track count data indicative of inflows and outflows from nodes of a trie data structure. Further, and as described in more detail, the operations may include updating count data associated with a selected portion of a trie data structure to enable an accurate drilled-down view of the portion of the trie data structure. Accordingly, a system implementing the technologies provided herein may make more efficient use of available processing capacity (e.g., available cycles of processing devices) to generate a trie data structure for a given organization and may perform operations to ensure that accurate count information is determined for nodes of a trie data structure represented in a visualization.

It should be appreciated that a “trie data structure” may be simply referred to herein as a “trie” for simplicity and brevity of the description. Further, although the technologies are described herein in reference to “bot flows,” it should be appreciated that similar technologies may be applied to other types of flows or client journeys in other embodiments.

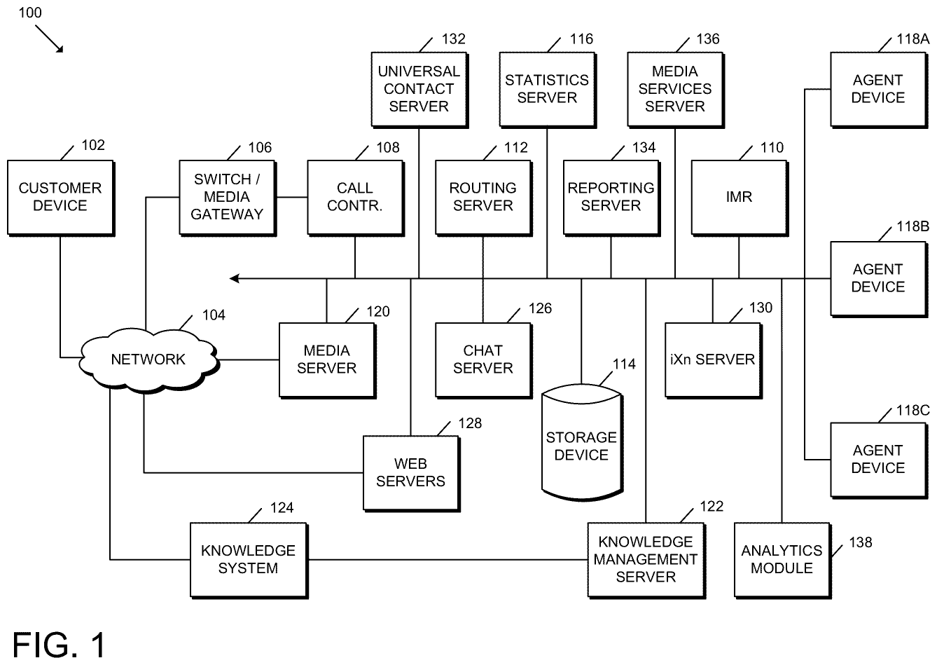

Referring now to FIG. 1, a simplified block diagram of at least one embodiment of a communications infrastructure and/or contact center system, which may be used in conjunction with one or more of the embodiments described herein, is shown. The contact center system 100 may be embodied as any system capable of providing contact center services (e.g., call center services, chat center services, SMS center services, etc.) to a customer and otherwise performing the functions described herein. The illustrative contact center system 100 includes a customer device 102, a network 104, a switch/media gateway 106, a call controller 108, an interactive media response (IMR) server 110, a routing server 112, a storage device 114, a statistics server 116, agent devices 118A, 118B, 118C, a media server 120, a knowledge management server 122, a knowledge system 124, chat server 126, web servers 128, an interaction (iXn) server 130, a universal contact server 132, a reporting server 134, a media services server 136, and an analytics module 138. Although only one customer device 102, one network 104, one switch/media gateway 106, one call controller 108, one IMR server 110, one routing server 112, one storage device 114, one statistics server 116, one media server 120, one knowledge management server 122, one knowledge system 124, one chat server 126, one iXn server 130, one universal contact server 132, one reporting server 134, one media services server 136, and one analytics module 138 are shown in the illustrative embodiment of FIG. 1, the contact center system 100 may include multiple customer devices 102, networks 104, switch/media gateways 106, call controllers 108, IMR servers 110, routing servers 112, storage devices 114, statistics servers 116, media servers 120, knowledge management servers 122, knowledge systems 124, chat servers 126, iXn servers 130, universal contact servers 132, reporting servers 134, media services servers 136, and/or analytics modules 138 in other embodiments. Further, in some embodiments, one or more of the components described herein may be excluded from the system 100, one or more of the components described as being independent may form a portion of another component, and/or one or more of the component described as forming a portion of another component may be independent.

It should be understood that the term “contact center system” is used herein to refer to the system depicted in FIG. 1 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 100), the associated customer service provider (such as a particular customer service provider/agent providing customer services through the contact center system 100), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals,” “customers,” or “contact center clients”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots,” automated chat modules or “chatbots,” and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 100 may be used by a customer service provider to provide various types of services to customers. For example, the contact center system 100 may be used to engage and manage interactions in which automated processes (or bots) or human agents communicate with customers. As should be understood, the contact center system 100 may be an in-house facility to a business or enterprise for performing the functions of sales and customer service relative to products and services available through the enterprise. In another embodiment, the contact center system 100 may be operated by a third-party service provider that contracts to provide services for another organization. Further, the contact center system 100 may be deployed on equipment dedicated to the enterprise or third-party service provider, and/or deployed in a remote computing environment such as, for example, a private or public cloud environment with infrastructure for supporting multiple contact centers for multiple enterprises. The contact center system 100 may include software applications or programs, which may be executed on premises or remotely or some combination thereof. It should further be appreciated that the various components of the contact center system 100 may be distributed across various geographic locations and not necessarily contained in a single location or computing environment.

It should further be understood that, unless otherwise specifically limited, any of the computing elements of the present invention may be implemented in cloud-based or cloud computing environments. As used herein and further described below in reference to the computing device 200, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

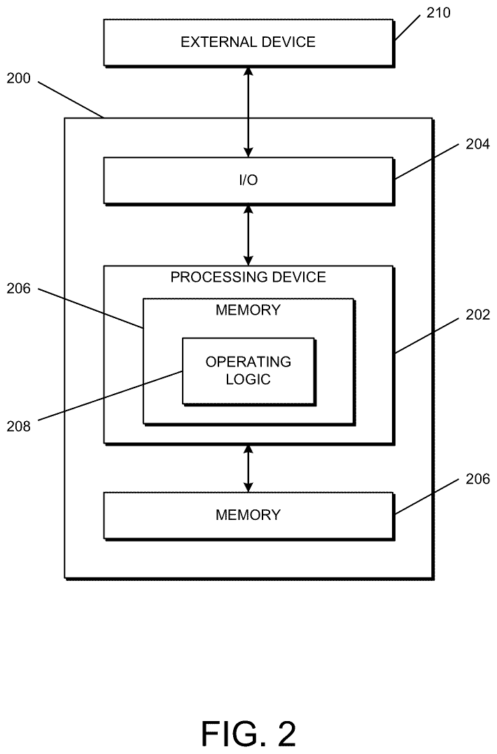

It should be understood that any of the computer-implemented components, modules, or servers described in relation to FIG. 1 may be implemented via one or more types of computing devices, such as, for example, the computing device 200 of FIG. 2. As will be seen, the contact center system 100 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 100 may initiate inbound communications (e.g., telephone calls, emails, chats, etc.) to the contact center system 100 via a customer device 102. While FIG. 1 shows one such customer device—i.e., customer device 102—it should be understood that any number of customer devices 102 may be present. The customer devices 102, for example, may be a communication device, such as a telephone, smart phone, computer, tablet, or laptop. In accordance with functionality described herein, customers may generally use the customer devices 102 to initiate, manage, and conduct communications with the contact center system 100, such as telephone calls, emails, chats, text messages, web-browsing sessions, and other multi-media transactions.

Inbound and outbound communications from and to the customer devices 102 may traverse the network 104, with the nature of the network typically depending on the type of customer device being used and the form of communication. As an example, the network 104 may include a communication network of telephone, cellular, and/or data services. The network 104 may be a private or public switched telephone network (PSTN), local area network (LAN), private wide area network (WAN), and/or public WAN such as the Internet. Further, the network 104 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 106 may be coupled to the network 104 for receiving and transmitting telephone calls between customers and the contact center system 100. The switch/media gateway 106 may include a telephone or communication switch configured to function as a central switch for agent level routing within the center. The switch may be a hardware switching system or implemented via software. For example, the switch 106 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 118. Thus, in general, the switch/media gateway 106 establishes a voice connection between the customer and the agent by establishing a connection between the customer device 102 and agent device 118.

As further shown, the switch/media gateway 106 may be coupled to the call controller 108 which, for example, serves as an adapter or interface between the switch and the other routing, monitoring, and communication-handling components of the contact center system 100. The call controller 108 may be configured to process PSTN calls, VoIP calls, and/or other types of calls. For example, the call controller 108 may include computer-telephone integration (CTI) software for interfacing with the switch/media gateway and other components. The call controller 108 may include a session initiation protocol (SIP) server for processing SIP calls. The call controller 108 may also extract data about an incoming interaction, such as the customer's telephone number, IP address, or email address, and then communicate these with other contact center components in processing the interaction.

The interactive media response (IMR) server 110 may be configured to enable self-help or virtual assistant functionality. Specifically, the IMR server 110 may be similar to an interactive voice response (IVR) server, except that the IMR server 110 is not restricted to voice and may also cover a variety of media channels. In an example illustrating voice, the IMR server 110 may be configured with an IMR script for querying customers on their needs. For example, a contact center for a bank may instruct customers via the IMR script to “press 1” if they wish to retrieve their account balance. Through continued interaction with the IMR server 110, customers may receive service without needing to speak with an agent. The IMR server 110 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment.

The routing server 112 may function to route incoming interactions. For example, once it is determined that an inbound communication should be handled by a human agent, functionality within the routing server 112 may select the most appropriate agent and route the communication thereto. This agent selection may be based on which available agent is best suited for handling the communication. More specifically, the selection of appropriate agent may be based on a routing strategy or algorithm that is implemented by the routing server 112. In doing this, the routing server 112 may query data that is relevant to the incoming interaction, for example, data relating to the particular customer, available agents, and the type of interaction, which, as described herein, may be stored in particular databases. Once the agent is selected, the routing server 112 may interact with the call controller 108 to route (i.e., connect) the incoming interaction to the corresponding agent device 118. As part of this connection, information about the customer may be provided to the selected agent via their agent device 118. This information is intended to enhance the service the agent is able to provide to the customer.

It should be appreciated that the contact center system 100 may include one or more mass storage devices—represented generally by the storage device 114—for storing data in one or more databases relevant to the functioning of the contact center. For example, the storage device 114 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 114 may store agent data in an agent database. Agent data maintained by the contact center system 100 may include, for example, agent availability and agent profiles, schedules, skills, handle time, and/or other relevant data. As another example, the storage device 114 may store interaction data in an interaction database. Interaction data may include, for example, data relating to numerous past interactions between customers and contact centers. More generally, it should be understood that, unless otherwise specified, the storage device 114 may be configured to include databases and/or store data related to any of the types of information described herein, with those databases and/or data being accessible to the other modules or servers of the contact center system 100 in ways that facilitate the functionality described herein. For example, the servers or modules of the contact center system 100 may query such databases to retrieve data stored therein or transmit data thereto for storage. The storage device 114, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 116 may be configured to record and aggregate data relating to the performance and operational aspects of the contact center system 100. Such information may be compiled by the statistics server 116 and made available to other servers and modules, such as the reporting server 134, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 118 of the contact center system 100 may be communication devices configured to interact with the various components and modules of the contact center system 100 in ways that facilitate functionality described herein. An agent device 118, for example, may include a telephone adapted for regular telephone calls or VoIP calls. An agent device 118 may further include a computing device configured to communicate with the servers of the contact center system 100, perform data processing associated with operations, and interface with customers via voice, chat, email, and other multimedia communication mechanisms according to functionality described herein. Although FIG. 1 shows three such agent devices 118—i.e., agent devices 118A, 118B and 118C—it should be understood that any number of agent devices 118 may be present in a particular embodiment.

The multimedia/social media server 120 may be configured to facilitate media interactions (other than voice) with the customer devices 102 and/or the servers 128. Such media interactions may be related, for example, to email, voice mail, chat, video, text-messaging, web, social media, co-browsing, etc. The multimedia/social media server 120 may take the form of any IP router conventional in the art with specialized hardware and software for receiving, processing, and forwarding multi-media events and communications.

The knowledge management server 122 may be configured to facilitate interactions between customers and the knowledge system 124. In general, the knowledge system 124 may be a computer system capable of receiving questions or queries and providing answers in response. The knowledge system 124 may be included as part of the contact center system 100 or operated remotely by a third party. The knowledge system 124 may include an artificially intelligent computer system capable of answering questions posed in natural language by retrieving information from information sources such as encyclopedias, dictionaries, newswire articles, literary works, or other documents submitted to the knowledge system 124 as reference materials. As an example, the knowledge system 124 may be embodied as IBM Watson or a similar system.

The chat server 126, it may be configured to conduct, orchestrate, and manage electronic chat communications with customers. In general, the chat server 126 is configured to implement and maintain chat conversations and generate chat transcripts. Such chat communications may be conducted by the chat server 126 in such a way that a customer communicates with automated chatbots, human agents, or both. In exemplary embodiments, the chat server 126 may perform as a chat orchestration server that dispatches chat conversations among the chatbots and available human agents. In such cases, the processing logic of the chat server 126 may be rules driven so to leverage an intelligent workload distribution among available chat resources. The chat server 126 further may implement, manage, and facilitate user interfaces (UIs) associated with the chat feature, including those UIs generated at either the customer device 102 or the agent device 118. The chat server 126 may be configured to transfer chats within a single chat session with a particular customer between automated and human sources such that, for example, a chat session transfers from a chatbot to a human agent or from a human agent to a chatbot. The chat server 126 may also be coupled to the knowledge management server 122 and the knowledge systems 124 for receiving suggestions and answers to queries posed by customers during a chat so that, for example, links to relevant articles can be provided.

The web servers 128 may be included to provide site hosts for a variety of social interaction sites to which customers subscribe, such as Facebook, Twitter, Instagram, etc. Though depicted as part of the contact center system 100, it should be understood that the web servers 128 may be provided by third parties and/or maintained remotely. The web servers 128 may also provide webpages for the enterprise or organization being supported by the contact center system 100. For example, customers may browse the webpages and receive information about the products and services of a particular enterprise. Within such enterprise webpages, mechanisms may be provided for initiating an interaction with the contact center system 100, for example, via web chat, voice, or email. An example of such a mechanism is a widget, which can be deployed on the webpages or websites hosted on the web servers 128. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 130 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 130 may be configured to interact with the routing server 112 for selecting an appropriate agent to handle each of the deferrable activities. Once assigned to a particular agent, the deferrable activity is pushed to that agent so that it appears on the agent device 118 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 118 may include a workbin. As an example, a workbin may be maintained in the buffer memory of the corresponding agent device 118.

The universal contact server (UCS) 132 may be configured to retrieve information stored in the customer database and/or transmit information thereto for storage therein. For example, the UCS 132 may be utilized as part of the chat feature to facilitate maintaining a history on how chats with a particular customer were handled, which then may be used as a reference for how future chats should be handled. More generally, the UCS 132 may be configured to facilitate maintaining a history of customer preferences, such as preferred media channels and best times to contact. To do this, the UCS 132 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 134 may be configured to generate reports from data compiled and aggregated by the statistics server 116 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 136 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), screen recording, speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 138 may be configured to provide systems and methods for performing analytics on data received from a plurality of different data sources as functionality described herein may require. In accordance with example embodiments, the analytics module 138 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 138 may have access to the data stored in the storage device 114, including the customer database and agent database. The analytics module 138 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 138 may be configured to retrieve data stored within the storage device 114 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 138 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 138 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 1 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact center system 100 may be affected through user interfaces (UIs) which may be generated on the customer devices 102 and/or the agent devices 118.

As noted above, in some embodiments, the contact center system 100 may operate as a hybrid system in which some or all components are hosted remotely, such as in a cloud-based or cloud computing environment. It should be appreciated that each of the devices of the contact center system 100 may be embodied as, include, or form a portion of one or more computing devices similar to the computing device 200 described below in reference to FIG. 2.

Referring now to FIG. 2, a simplified block diagram of at least one embodiment of a computing device 200 is shown. The illustrative computing device 200 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the various computing devices may be a process or thread running on one or more processors of one or more computing devices 200, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein—such as the contact center system 100 of FIG. 1—the various servers and computer devices thereof may be located on local computing devices 200 (e.g., on-site at the same physical location as the agents of the contact center), remote computing devices 200 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, Fire Wire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network. The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (IP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

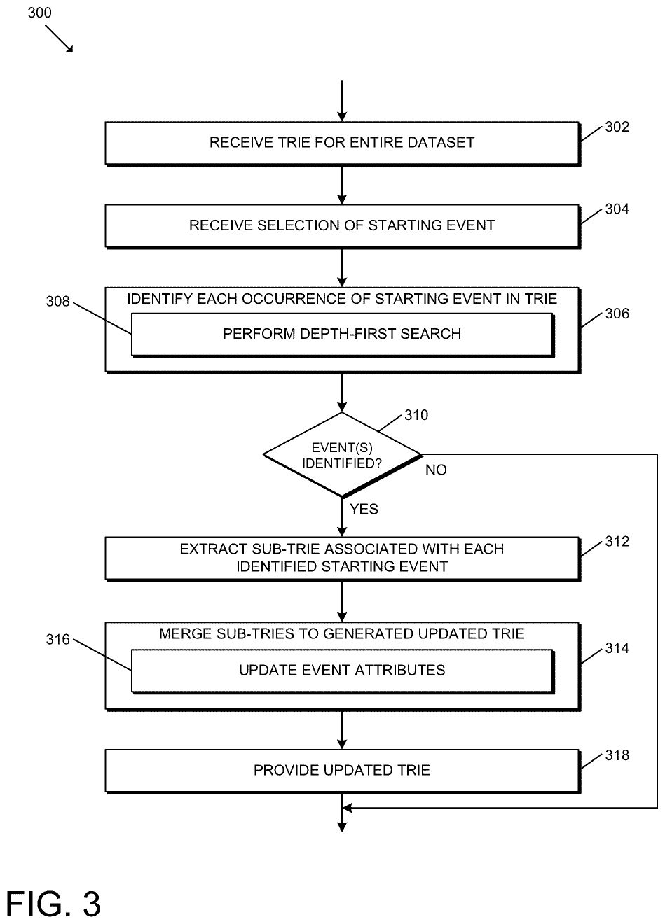

Referring now to FIG. 3, in use, a computing system (e.g., the contact center system 100, one or more computing devices 200, and/or other computing devices described herein) may execute a method 300 for filtering a trie data structure by a specific event. It should be appreciated that the particular blocks of the method 300 are illustrated by way of example, and such blocks may be combined or divided, added or removed, and/or reordered in whole or in part depending on the particular embodiment, unless stated to the contrary.

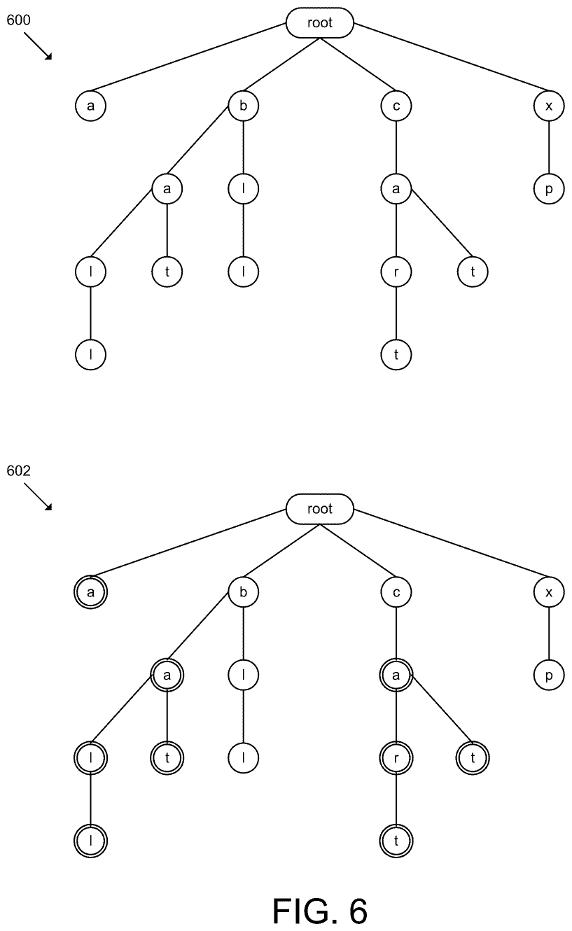

The illustrative method 300 begins with block 302 in which the computing system receives a trie for the entire data set for the organization. For example, as described above, the illustrative technologies may involve the creation of a single “big picture” trie that includes all of the bot flows (e.g., including relative attributes and/or other metadata) for the organization. For simplicity and brevity of the description, this trie may be referred to as a “mother trie” or a “big picture trie.” This mother trie is able to be received by or otherwise accessed by the computing system (e.g., for filtering and querying). FIG. 6 illustrates an example trie in a state 600 in which it has been organized as a “big picture” mother trie (e.g., the state in which the trie is stored). In other embodiments, it should be appreciated that the mother trie may include a plurality of bot flows of the organization, but not necessarily all of the bot flows. For example, a particular organization may have an interest in partitioning its analyses and/or visualizations of bot flows and events.

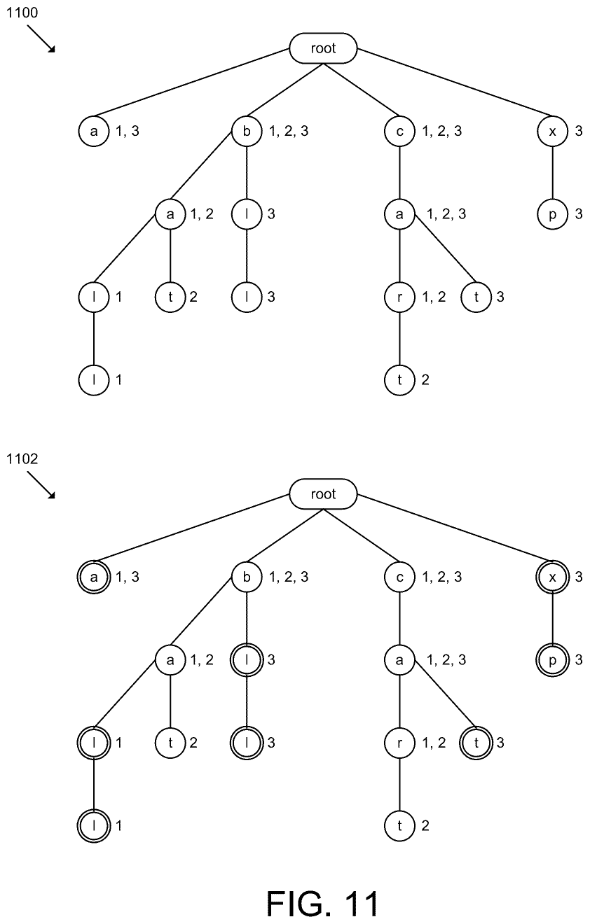

As described above, FIG. 6 illustrates the initial state 600 of an example “big picture” mother trie after it has been created. The illustrative trie is a simple example created for an organization that includes three basic bot flows. For simplicity and clarity of the description, the possible event sequences or “journeys” are described in reference to “words.” A first bot flow includes the journeys BALL (representing a sequence of the events B, A, L, and L), CAR (representing a sequence of the events C, A, and R), and A (representing a sequence including only the event A). A second bot flow includes the journeys BAT (representing a sequence of the events B, A, and T) and CART (representing a sequence of the events C, A, R, and T). A third bot flow includes the journeys CAT (representing a sequence of the events C, A, and T), A (representing a sequence including only the event A), XP (representing a sequence of the events X and P), and BLL (representing a sequence of the events B, L, and L). The same trie is also illustrated in state 1100 of FIG. 11, which further illustrates the bot flow identifiers of the bot flows associated with each event adjacent the corresponding event.

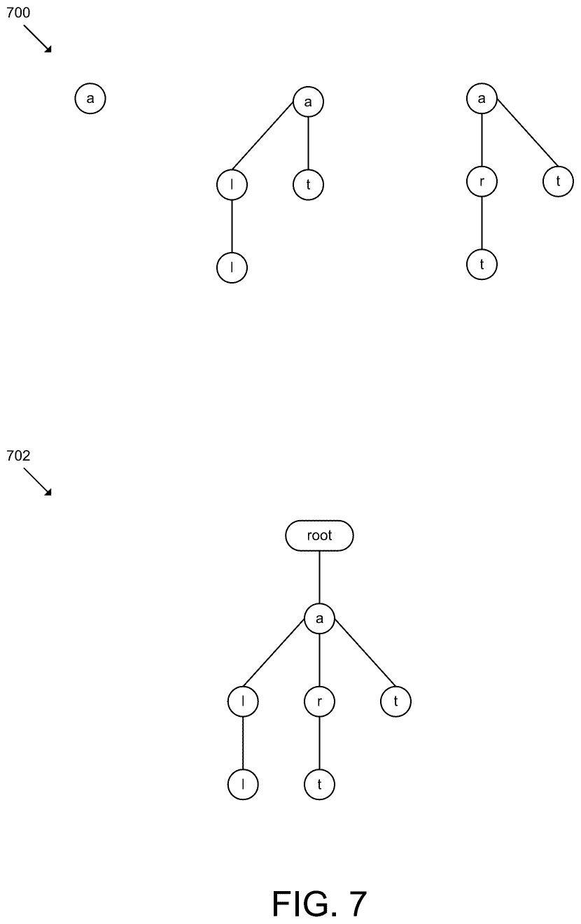

In block 304, the computing system receives a selection of a starting event of the trie by which to filter the trie. For example, as described above, an administrative user may visualize the trie in a graphical user interface and provide user input indicating that the user would like to filter the trie to include only events that include a particular starting event. In the illustrative embodiment of FIGS. 6-7, the user has selected the event “a” to be the starting event. In block 306, the computing system identifies each occurrence of the selected starting event in the trie. For example, as depicted in the state 602 of FIG. 6, the computing system has identified each occurrence of the event “a” in the mother trie, which includes each of the events in the data set as described above. In some embodiments, in block 308, the computing system may perform a depth first search in order to identify each occurrence of the selected starting event in the trie. In other embodiments, the computing system may utilize another search algorithm. In some embodiments, it should be appreciated that, in finding each occurrence of a particular starting event (e.g., the event “a” of the state 602 of FIG. 6), the computing system may also identify each sub-trie that includes the selected event as the starting event (e.g., the three sub-tries highlighted in the state 602 of FIG. 6).

If the computing system determines, in block 310, that one or more occurrences of the selected event have been identified in the trie, the method 300 advances to block 312 in which the computing system extracts the sub-trie associated with each identified starting event. For example, as depicted in the state 700 of FIG. 7, the computing system has extracted three sub-tries from the trie of state 602, each of which sub-trie starts with the selected event “a.” In block 314, the computing system merges the extracted sub-tries to generate an updated trie. For example, as depicted in the state 702 of FIG. 7, the computing system has merged the three illustrative sub-tries of state 700 into a single trie. It should be appreciated that the resultant updated trie satisfies the properties of a trie and, therefore, duplicative journeys are not present, for example. In block 316, the computing system updates the event attributes of the merged and updated trie. For example, if an event in the merged trie was previously present in multiple sub-tries, the counts of the events from the sub-tries may be aggregated, and/or the other attributes may be aggregated or otherwise combined.

In block 318, the computing system provides the updated trie to the administrative user. For example, in some embodiments, the updated trie may be returned to the requesting administrative user device for display on a graphical user interface, for visualization by the administrative user.

Although the blocks 302-318 are described in a relatively serial manner, it should be appreciated that various blocks of the method 300 may be performed in parallel in some embodiments.

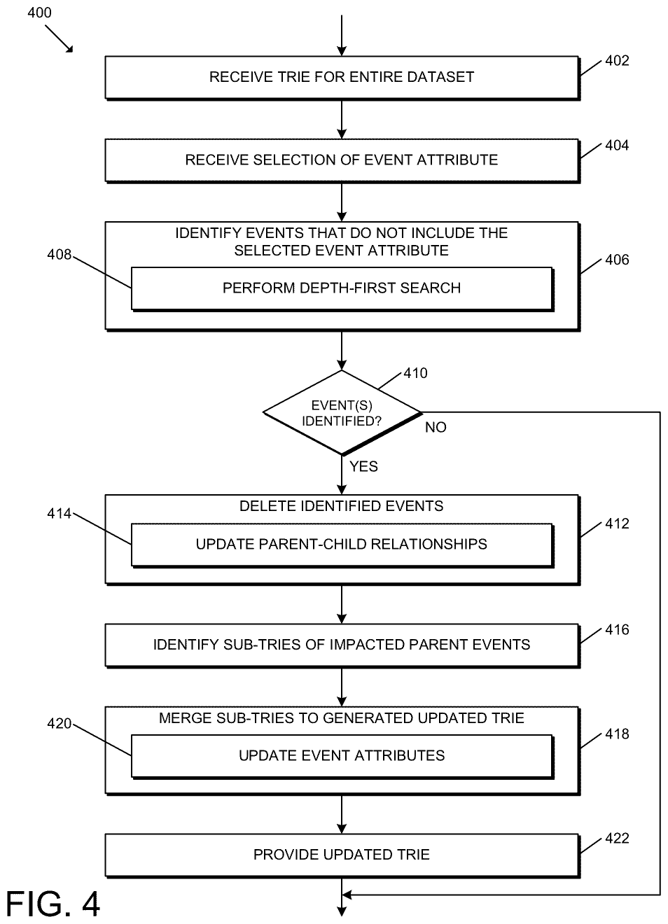

Referring now to FIG. 4, in use, a computing system (e.g., the contact center system 100, one or more computing devices 200, and/or other computing devices described herein) may execute a method 400 for filtering a trie data structure by an event attribute. It should be appreciated that the particular blocks of the method 400 are illustrated by way of example, and such blocks may be combined or divided, added or removed, and/or reordered in whole or in part depending on the particular embodiment, unless stated to the contrary.

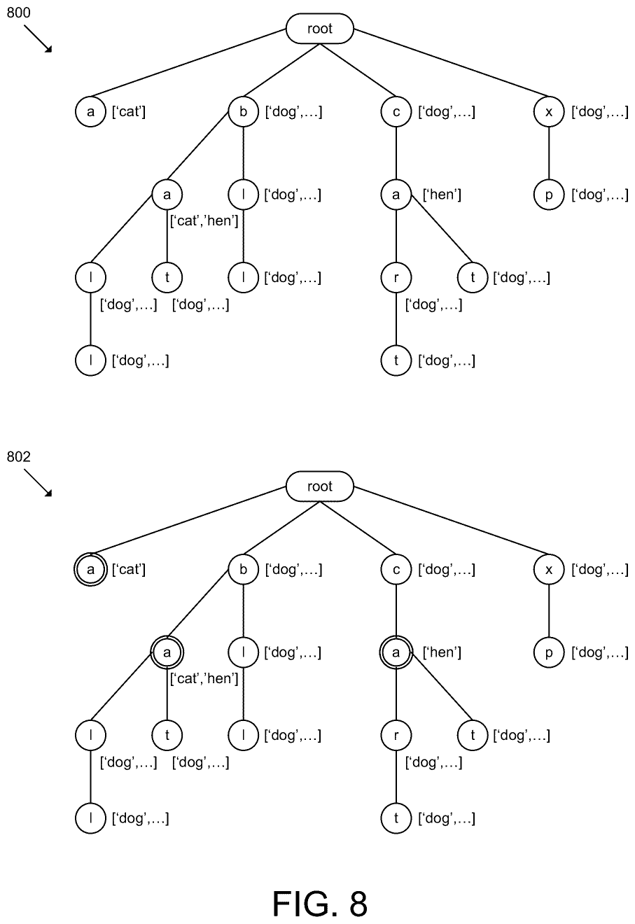

The illustrative method 400 begins with block 402 in which the computing system receives a trie for the entire data set for the organization. For example, as described above, the illustrative technologies may involve the creation of a single “big picture” trie that includes all of the bot flows (e.g., including relative attributes and/or other metadata) for the organization (e.g., a “mother trie”). FIG. 8 illustrates an example trie in a state 800 in which it has been organized as a “big picture” mother trie (e.g., the state in which the trie is stored). The illustrative trie is a simple example created for an organization that includes the three basic bot flows described above. However, in the illustrative embodiment, each of the events includes an “animal” attribute, which includes possible values of at least “dog,” “cat,” and/or “hen.” The attribute values associated with each event are illustrated in FIGS. 8-10 adjacent each corresponding event.

In block 404, the computing system receives a selection of an event attribute of the trie by which to filter the trie or, more specifically, an event attribute value of the trie by which to filter the trie. For example, as described above, an administrative user may visualize the trie in a graphical user interface and provide user input indicating that the user would like to filter the trie to include only events that include a particular selected event attribute value. For example, in the illustrative embodiment of FIGS. 8-10, the user has selected the “animal” attribute and, more specifically, the attribute value of “dog.” In block 406, the computing system identifies each event that does not include the selected event attribute or, more specifically, the selected event attribute value in the trie. For example, as depicted in the state 802 of FIG. 8, the computing system has identified each event/node that does not include the attribute value “dog.” That is, one event was identified as including the attribute value “cat,” one event was identified as including the attribute value [“cat”, “hen”], and another event was identified as including the attribute value “hen.” In some embodiments, the computing system may perform a depth first search in order to identify each event in the trie that does not include the selected event attribute value. In other embodiments, the computing system may utilize another search algorithm.

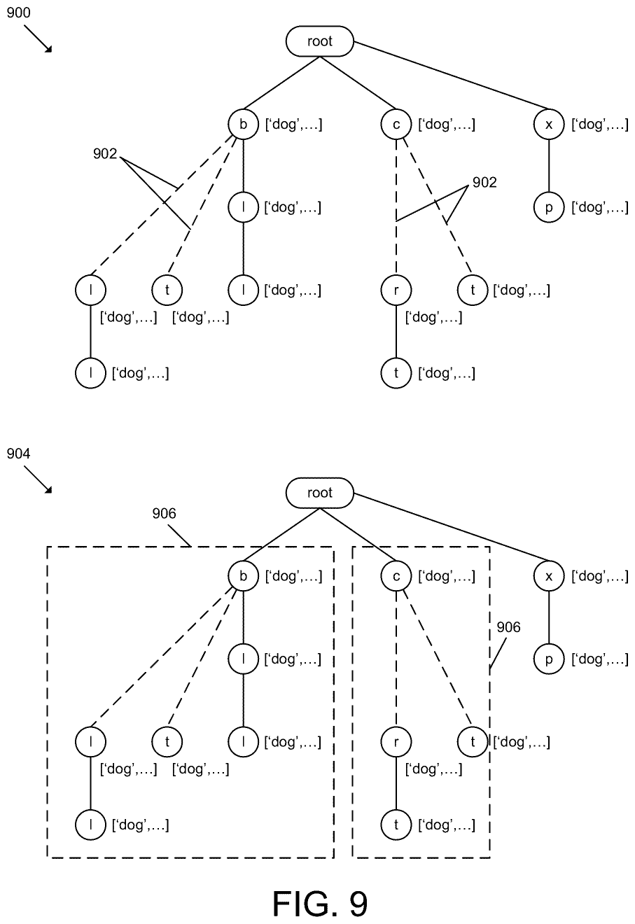

If the computing system determines, in block 410, that one or more events have been identified that does not included the selected event attribute value, the method 400 advances to block 412 in which the computing system deletes the identified events from the trie. In doing so, in block 414, the computing system may update the parent-child relationships impacted by the deletion of the identified events. For example, the prior parent event/node of the deleted event may be temporarily connected (e.g., via a pointer) to the prior child events/nodes of the deleted event. As depicted in the state 900 of FIG. 9, the computing system has deleted each of the identified events and created the temporary connections 902 to update the parent/child relationships impacted by the deletion of the events.

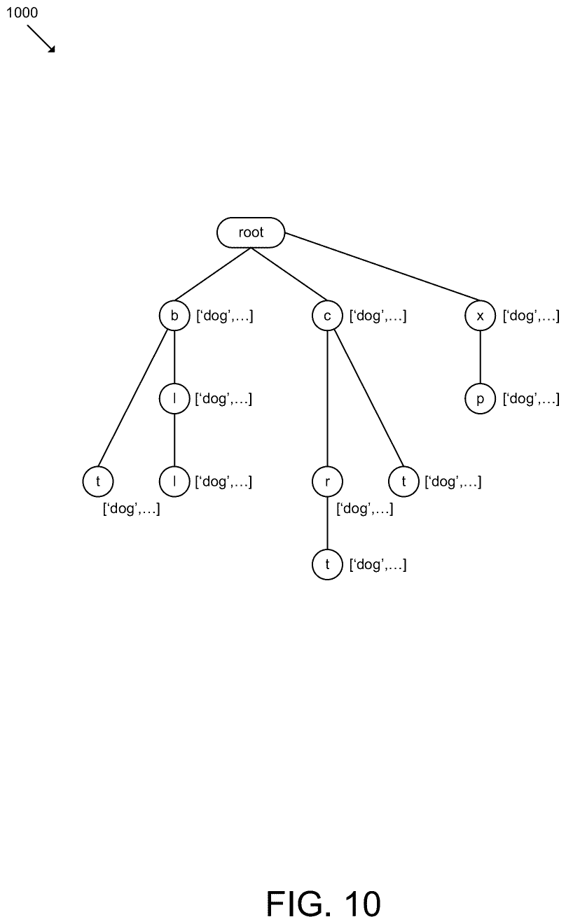

In block 416, the computing system identifies each of the sub-tries of the parent events impacted by the deletion of the events. For example, in some embodiments, each prior parent event/node of a deleted event may be identified as the eldest parent node or root node of a sub-trie. For example, as depicted in the state 904 of FIG. 9, the computing system has identified the sub-tries 906 based on the deleted events. In block 418, the computing system merges the identified sub-tries (e.g., merges the events within each corresponding sub-trie) to generate an updated trie. For example, as depicted in the state 1000 of FIG. 10, the computing system has merged the two illustrative sub-tries 906 of FIG. 9 to create a single trie. As described above, it should be appreciated that the resultant updated trie satisfies the properties of a trie and, therefore, duplicative journeys are not present, for example. In block 420, the computing system updates the event attributes of the merged and updated trie. For example, if an event in the merged trie was previously present in multiple sub-tries, the counts of the events from the sub-tries may be aggregated, and/or the other attributes may be aggregated or otherwise combined.

In block 422, the computing system provides the updated trie to the administrative user. For example, in some embodiments, the updated trie may be returned to the requesting administrative user device for display on a graphical user interface, for visualization by the administrative user.

Although the blocks 402-422 are described in a relatively serial manner, it should be appreciated that various blocks of the method 400 may be performed in parallel in some embodiments.

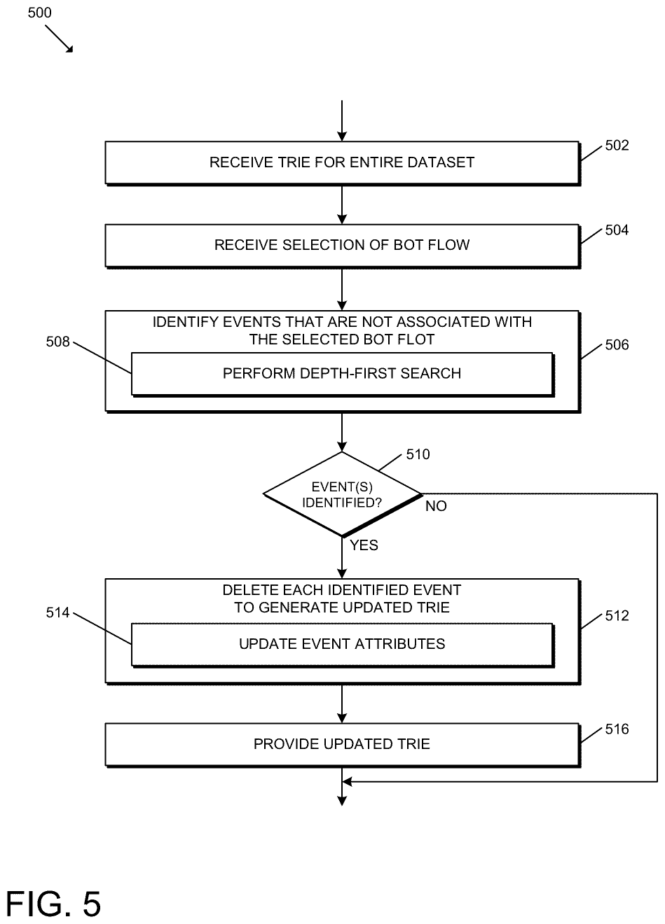

Referring now to FIG. 5, in use, a computing system (e.g., the contact center system 100, one or more computing devices 200, and/or other computing devices described herein) may execute a method 500 for filtering a trie data structure by a bot flow. It should be appreciated that the particular blocks of the method 500 are illustrated by way of example, and such blocks may be combined or divided, added or removed, and/or reordered in whole or in part depending on the particular embodiment, unless stated to the contrary.

The illustrative method 500 begins with block 502 in which the computing system receives a trie for the entire data set for the organization. For example, as described above, the illustrative technologies may involve the creation of a single “big picture” trie that includes all of the bot flows (e.g., including relative attributes and/or other metadata) for the organization (e.g., a “mother” trie). FIG. 11 illustrates an example trie in a state 1100 in which it has been organized as a “big picture” mother trie (e.g., the state in which the trie is stored). As shown in FIG. 11, the state 1100 also illustrates the bot flow identifiers (of bot flow 1, bot flow 2, and bot flow 3) associated with each event adjacent the corresponding event.

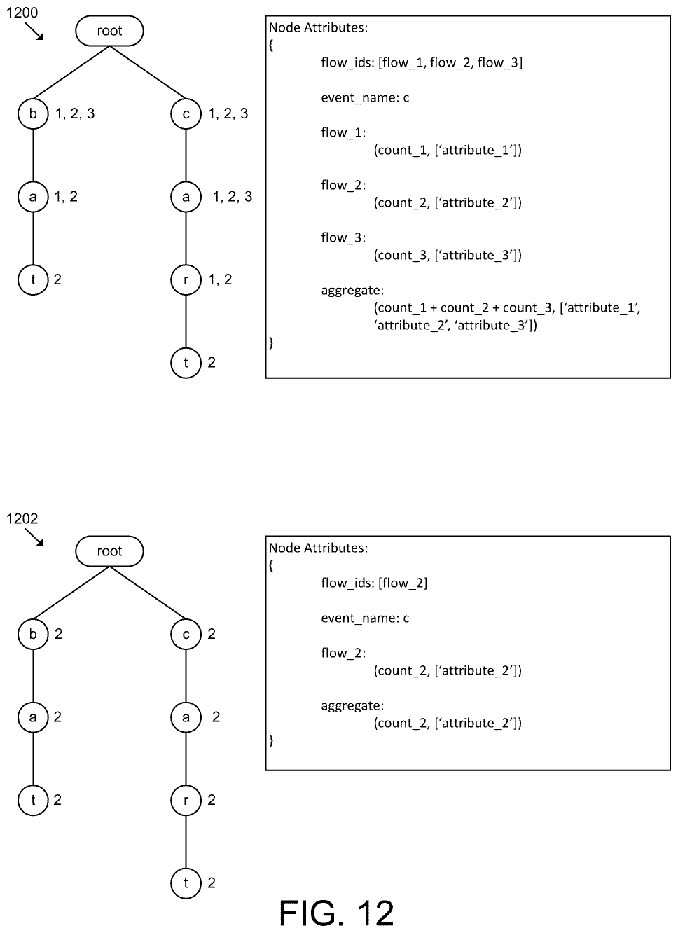

In block 504, the computing system receives a selection of a bot flow of the trie by which to filter the trie. For example, as described above, an administrative user may visualize the trie in a graphical user interface and provide user input indicating that the user would like to filter the trie to include only events that are associated with a particular bot flow. In the illustrative embodiment of FIGS. 11-12, the user has selected to filter the trie to include only events that are from bot flow 2. In block 506, the computing system identifies each event that is not associated with the selected bot flow (e.g., based on associated bot flow identifiers stored as attributes in association with the events). For example, as depicted in the state 1102 of FIG. 11, the computing system has identified each event/node that is not associated with bot flow 2. Those events associated with only bot flow 1 and/or bot flow 3 (and therefore not bot flow 2) have been highlighted for illustrative purposes. In some embodiments, the computing system may perform a depth first search in order to identify each event in the trie that is not associated with the selected bot flow. In other embodiments, the computing system may utilize another search algorithm.

If the computing system determines, in block 510, that one or more events have been identified that are not associated with the selected bot flow, the method 500 advances to block 512 in which the computing system deletes the identified events from the trie. It should be appreciated that if a particular event/node is not associated with a particular bot flow, then none of its children will be associated with that particular bot flow as a matter of inherency. Accordingly, in some embodiments, during a depth first search, the computing system may identify an event/node that is not associated with the selected flow and delete the entire sub-trie of that node without further searching of that sub-trie, which makes the search more efficient. As depicted in the state 1200 of FIG. 12, the computing system has deleted each of the identified events to generate an updated trie. In block 514, the computing system updates the event attributes of the updated trie. It should be appreciated that the deletion of non-selected bot flows may result in the frequency counts changing for events, and attributes may be updated as well as described above. For example, the event/node attributes of the state 1200 reflect the counts and/or other attributes from before deletion of the identified events, whereas the event/node attributes of the state 1202 reflect the updated counts and/or other attributes after deletion of the identified events. Additionally, it should be appreciated that bot flow 2 is the only bot flow identified as being associated with the remaining events.

In block 516, the computing system provides the updated trie to the administrative user. For example, in some embodiments, the updated trie may be returned to the requesting administrative user device for display on a graphical user interface, for visualization by the administrative user.

Although the blocks 502-516 are described in a relatively serial manner, it should be appreciated that various blocks of the method 500 may be performed in parallel in some embodiments.

To support the generation of visualizations of trie data structures, a computing system (e.g., the contact center system 100, one or more computing devices 200, and/or other computing devices described herein) may perform operations to split the processing of a data frame (e.g., a data structure having rows and columns) of events associated with bot flows. In doing so, the computing system may partition a data frame into multiple partitions to be operated on by separate execution units (e.g., processing devices 202), to produce corresponding trie data structures. The computing system may selectively merge trie data structures, such as those associated with the same organization, to produce a combined trie data structure indicative of events associated with bot flows related to that organization. As will be appreciated, the operations enable more efficient use of available processing capacity in the computing system, resulting in faster generation and manipulation of trie data structures. Further, the computing system may perform operations to accurately track data associated with nodes of a trie data structure represented in a visualization (e.g., in a user interface) as the visualization is manipulated (e.g., when a user selects a portion of the trie data structure for a drilled-down view).

Embodiments of the contact center system 100 enable path discovery, which is a type of journey management feature that provides an aggregate view into the most frequently occurring journeys of customers that affect bot containment (i.e., whether a customer escalates from interaction with an automated agent (a bot) to a human agent). Such an escalation may be indicative of a lack of ability of the automated agent to address the needs of the customer and may significantly influence the customer experience. Path discovery may be utilized in other domains relating to journey management that may involve different source datasets and/or the application of different algorithms or data structures. Accordingly, in the illustrative embodiment, flexibility is built into application programming interface (API) contracts associated with the domains. An API contract may be embodied as a technical specification that defines the rules and expectations for how an API should be used, including details such as endpoints, data formats, authentication methods, and the structures of requests and responses between components of a system that utilize the API. In at least some embodiments, path discovery operations do not require configuration and may be executed in a periodic (e.g., nightly) batch process to produce results for one or more organizations associated with the contact center system 100. Accordingly, in at least some embodiments, the contact center system 100 provides a read-only endpoint as the primary API resource. That primary API resource, in at least some embodiments, provides path result sets and filtering capabilities to drill down to specific subsets of paths, such as drilling down from paths across all flows in an organization to paths for one specific flow, in accordance with the operations described above.

As will be appreciated from the description, a single path represents an aggregated sequence of customer journey events whereas a set of paths represents a collection of aggregated customer journey event sequences. Further, information about paths utilized by the contact center system 100, in the illustrative embodiment, includes counts for each distinct branching path. That is, the count for a given distinct branching path represents the number of times customer(s) followed that particular path. In performing path discovery operations, the contact center system 100 determines paths from a given data set. Further, as used herein, a path domain represents a high-level container to group path discovery use cases. Within a given domain, the data structures and algorithms used are consistent. A path category, in the context of the contact center system 100 represents a set of paths that correspond to a specific use case or insight in a given path domain. Structurally, one path domain may contain multiple path categories. A path direction refers to the direction of the paths. Paths are typically unidirectional, in which the direction refers to whether the paths start at a particular event and diverge outwards or whether they converge at a particular end event. A path type, in the context of the contact center system 100, specifies the data structure used to represent the corresponding path.

As will be appreciated, a trie data structure (also referred to herein as a “trie”) is embodied as a tree data structure that aggregates the occurrence of specific unique sequences of nodes. Further, a trie data structure, which may also be referred to as a digital tree or prefix tree in computer science, is used to locate specific keys from within a set. Traditionally, tries are utilized in autocompletion use cases to predict the most likely, by frequency, word based on a given sequence of input characters. That is, in such use cases, each node may represent a character in a word. Referring back to the structure of a trie, the keys may be embodied as strings, with links between nodes defined not by the entire key, but by individual characters. In order to access a key (e.g., to recover the corresponding value, change the value, or remove the value), the trie is traversed depth-first, following the links between nodes that represent each character in the key. Unlike a binary search tree, nodes in the trie do not store their associated key. Rather, a node's position in the trie defines the key with which it is associated. Defining the key of a node based on that node's position in the trie causes the value of each key to be distributed across the trie data structure and means that node every node necessarily has an associated value. All of the children of a node have a common prefix of the string associated with the parent node, and the root is associated with an empty string (i.e., the value of the root is an empty string). The task of storing data that can be accessed based on the prefix can be performed in a memory-efficient manner by employing a radix tree. A radix tree is a tree in which each node that is the only child is merged with its parent, thereby causing the number of children of every internal node to be, at most, the radix of the radix tree. Though tries can be keyed by character strings, they need not be. The same algorithms can be adapted for ordered lists of any underlying type, such as permutations of digits or shapes. A bitwise trie, in particular, is keyed on the individual bits making up a piece of fixed-length binary data, such as an integer or memory address. The key lookup complexity of a trie remains proportional to the key size. Specialized trie implementations, such as compressed tries are used to deal with the relatively large space requirement of a trie in naïve implementations.

In the context of path discovery for journey management use cases, for each path, a trie may represent a collection of journey event sequences. Further, a trie, in at least some embodiments, may be constructed from a set of six types of nodes. Each type of node represents important events on a customer journey and has corresponding unique characteristics. A root node is the starting point of the tree and is the only node without a parent node or a parent node identifier. An outcome node, in the illustrative embodiment, represents a flow outcome within a bot flow. The outcome node may be identified using a flowOutcomeId and flowOutcomeValue. The flowOutcomeValue represents whether the outcome represented by the outcome node was achieved (e.g., success or failure). A milestone node, in the illustrative embodiment, represents a flowMilestone within a bot flow. The milestone node may be identified using a flowMilestoneId and is associated with a flowOutcomeId. An error node may be embodied as a leaf node (i.e., a node with no children) and represents journey(s) that ended with a bot flow error. A transfer node may also be embodied as a leaf node (i.e., a node with no children) and represents the end of a customer journey, in which a customer was ultimately transferred from a bot (an automated agent) to a queue for a human agent. An escalation node may also be embodied as a leaf node and represents one or more journey(s) that ended with a customer expressly requesting (e.g., escalating) a transfer to a human agent queue, such as by stating “Can I speak to an agent?” An exit node may be embodied as a leaf node representing a normal termination of a flow execution.

Contact centers find customer journey data related to the way customers interact with contact center resources particularly useful for improving services and increasing efficiency. Pathway visualizations generated from such data are significant analytics tools that assist supervisors in managing resources and improving customer experiences, as such visualizations indicate the sequences of events that customers most often encounter as the customers navigate contact centers (e.g., when interacting with automated agent(s)). Some pathfinder applications, such as applications that are utilized to generate pathway visualizations, utilize trie data structures for efficient pathway calculations and related analytics. For example, some applications may utilize a library, such as the pygtrie library adapted for use with the Python programming language, to create and update trie data structures.

Within a given contact center, paths input data may be unevenly distributed across different organizations that utilize the contact center. Batch jobs may be grouped by organization identifiers and consolidated across all organization-specific data to individual executors (e.g., execution units). For relatively large organizations, the consolidation may result in data frames that are too large to be reliably read into memory and may cause faults if their size exceeds the available memory capacity. As described herein, in at least some embodiments, the contact center system 100 may perform operations to artificially increase the partition space with additional subpartitions under a given organization partition, and in doing so, address the reliability issue described above.

The contact center system 100 may partition an events data frame by organization identifier and sequence identifier. Preserving sequences of events is a significant factor in enabling processing of a corresponding trie data structure, as the sequence information indicates the path taken by a customer in their interactions with automated agents of the contact center system 100. Repartitioning by organization and sequence identifiers enables events from the same sequence to be collocated in the same partition, while also causing data associated with the organization to be distributed across multiple data partitions, and hence, multiple executors (e.g., execution units). Doing so enables the processing load to be distributed more evenly than may otherwise be possible. As used herein, data partitioning refers to splitting data into multiple partitions (e.g., sets). For example, in at least some embodiments, the data is split into multiple Apache Spark partitions. As such, the contact center system 100 may execute transformations on multiple partitions pertaining to event data for an organization in parallel, allowing for more expedient (e.g., faster) completion of the batch jobs than may otherwise be possible. In some embodiments, the contact center system 100 may write partitioned data into a file system (e.g., multiple sub-directories) for faster reads by downstream systems.

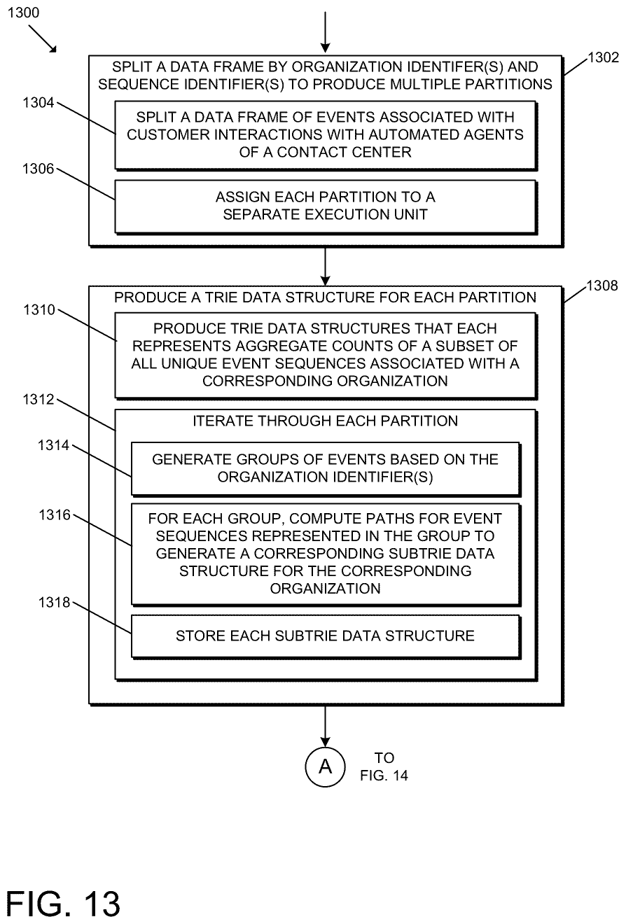

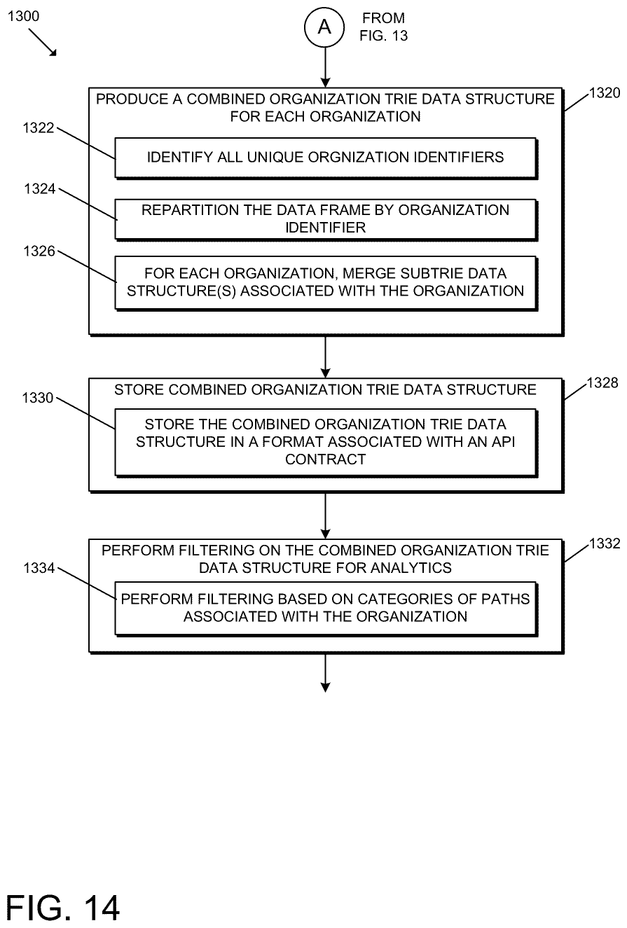

In the illustrative embodiment, the contact center system 100 computes a trie for each data partition. Doing so produces a trie that represents the aggregate counts of a subset of all the unique event sequences in the corresponding organization. The contact center system 100 then saves the tries to a storage location, such as a temporary S3 storage location, in an efficient intermediate format (e.g., a Python pickle). Further, after the tries have been created and persisted (e.g., stored), the contact center system 100 may generate a data frame that represents unique organization identifiers and may partition that data frame by organization identifiers. That is, the contact center system 100 may partition the data frame to create one partition for each organization identifier. For each resulting partition, the contact center system 100 may iterate through a list of identified organization sub partitions and merge all corresponding tries for a given organization into one larger trie. The contact center system 100 may save the resulting merged trie in a defined output location (e.g., in an S3 location). Further, the contact center system 100 may perform category (e.g., path category) filtering, such as to identify escalations, transfers, or other events on that trie. The merge operation described above, which may occur on a single executor (e.g., execution unit) utilizes significantly less memory and is less computationally intensive than the initial event processing that occurs during the computation of paths. A more detailed description of the process is provided below, with reference to FIGS. 13-14.

Referring now to FIG. 13, in use, a computing system (e.g., the contact center system 100, one or more computing devices 200, and/or other computing devices described herein) may execute a method 1300 for partitioning data for efficient processing of trie data structures. It should be appreciated that the particular blocks of the method 1300 are illustrated by way of example, and such blocks may be combined or divided, added or removed, and/or reordered in whole or in part depending on the particular embodiment, unless stated to the contrary.

The illustrative method 1300 begins with block 1302 in which the computing system splits a data frame (e.g., a data structure having rows and columns) by organization identifiers and sequence identifiers to produce multiple corresponding partitions. Further, and as indicated in block 1304, in the illustrative embodiment, the computing system splits a data frame that is representative of event associated with customer interactions with automated agents of a contact center. As described above, and as indicated in block 1306, the computing system may assign each resulting partition to a separate execution unit (e.g., processing device 202) to be processed in parallel.

Continuing the method 1300, in block 1308, the computing system, in the illustrative embodiment, produces a trie data structure for each partition that was produced in block 1302. In doing so, in block 1310, the computing system may produce trie data structures that each represents aggregate counts of a subset of all unique event sequences associated with a corresponding organization. Further, the computing system may iterate through each partition, as indicated in block 1312. For each iteration, the computing system may generate groups of events that are based on the organization identifiers (e.g., each group of events is associated with a shared organization identifier), as indicated in block 1314. Further, for each group, the computing system, in the illustrative embodiment, computes paths for event sequences represented in the group. In doing so, the computing system generates a corresponding subtrie data structure for the corresponding organization, as indicated in block 1316. Further, the computing system stores each subtrie data structure in block 1318.

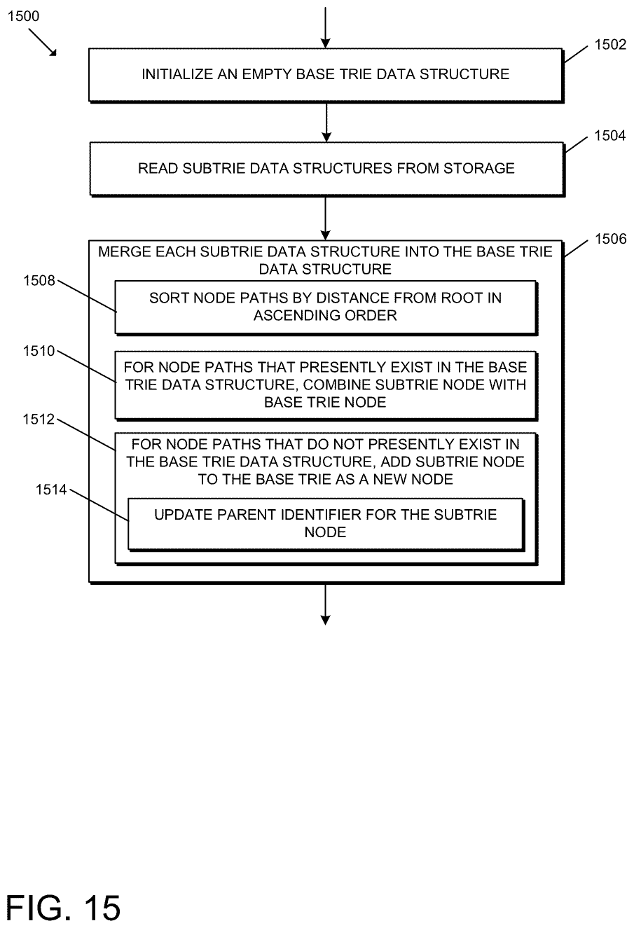

Continuing the method 1300, the computing system produces a combined organization trie data structure for each organization, in block 1320. In doing so, the computing system identifies all unique organization identifiers in block 1322. Further, the computing system repartitions the data frame based on the organization identifiers, as indicated in block 1324. That is, the computing system produces one partition per organization identifier. In block 1326, for each organization, the computing system merges the subtrie data structures associated with that organization. An embodiment of a method 1500 for merging the subtrie data structures is described with reference to FIG. 15.

Continuing the method 1300 in block 1328 of FIG. 14, the computing system stores the combined organization trie data structure for each organization. In doing so, the computing system may store the combined organization trie data structure in a format associated with an API contract, as indicated in block 1330. That is, the computing system may store the trie data structure in a format according to a technical specification that defines a set of rules and expectations for how the API should be used, including details such as endpoints, data formats, authentication methods, and the structures of requests and responses between components of a system that utilize the API. In particular, the API relates to transmitting and receiving data pertaining to trie data structures, such as to support visualization of a given trie data structure in a user interface. Continuing the method 1300, the computing system may perform filtering on the combined organization trie data structure for analytics, as indicated in block 1332. For example, and as indicated in block 1334, the computing system may perform filtering on the combined organization trie data structure based on one or more categories of paths associated with the organization (e.g., specific sequences of customer interactions with automated agents of the customer contact center 100 operating on behalf of the organization). Although the blocks 1302-1334 are described in a relatively serial manner, it should be appreciated that various blocks of the method 1300 may be performed in parallel in some embodiments.

Referring now to FIG. 15, in use, a computing system (e.g., the contact center system 100, one or more computing devices 200, and/or other computing devices described herein) may execute a method 1500 for merging trie data structures into a combined trie data structure. It should be appreciated that the particular blocks of the method 1500 are illustrated by way of example, and such blocks may be combined or divided, added or removed, and/or reordered in whole or in part depending on the particular embodiment, unless stated to the contrary.

The illustrative method 1500 begins with block 1502 in which the computing system initializes an empty base trie data structure. Further, the computing system reads subtrie data structures from storage (e.g., S3 storage) in block 1504. For example, the subtrie data structures may be the subtrie data structures generated in block 1316 of the method 1300. Continuing the method 1500, in block 1506, the computing system merges each subtrie data structure in the base trie data structure that was initialized in block 1502. In doing so, the computing system, in the illustrative embodiment, sorts node paths of the subtrie data structures based on distance from the root node, as indicated in block 1508. Further, in the illustrative embodiment, the computing system sorts the node paths in ascending order (e.g., from smallest distance to largest distance). For example, if a trie has node paths: ROOT, ROOT/A, ROOT/A/B, ROOT/A/C, ROOT/D, the computing system may sort the node paths as: ROOT, ROOT/A, ROOT/D, ROOT/A/B, ROOT/A/C, based on distance from the root.

As indicated in block 1510, for node paths (e.g., path from root to node) that exist in the base trie data structure already, the computing system combines the subtrie node with the base trie node. The combination includes merging and aggregation of flow counts for the two nodes that are being combined. Further, in the combination operation, the node identifier and the parent identifier of the base trie data structure take precedence. That is, the newly combined node has the node identifier and the parent identifier of the node in the base trie data structure, rather than that of the node from the subtrie that was merged into the base trie data structure.

Conversely, for node paths that do not presently exist in the base trie data structure, the computing system adds the corresponding subtrie node to the base trie data structure as a new node, as indicated in block 1512. In doing so, in block 1514, the computing system updates the parent identifier of the added node to the node identifier of the newly added node's parent node path in the base trie data structure. In the illustrative embodiment, the parent node path will exist in the base trie data structure, as the nodes are merged from the subtrie in sorted order of distance from the root, as described above. As will be appreciated, updating the parent identifier of the newly added node ensures consistency with the remainder of the base subtrie data structure. In the illustrative embodiment, the method 1500 may be performed as a portion of the method 1300 described above, resulting in the combined organization trie data structure described above relative to blocks 1320, 1328, and 1332. Although the blocks 1502-1514 are described in a relatively serial manner, it should be appreciated that various blocks of the method 1500 may be performed in parallel in some embodiments.

As briefly stated above, at least some embodiments of the contact center system 100 may perform operations to ensure that counts of inflow and outflow at each node in a trie data structure are accurate. That is, the contact center system 100 may perform operations to ensure that inflow and outflow counts at each node are equal in a visualization (e.g., a visual representation) of a set of paths associated with a trie data structure. In at least some embodiments, a user interface for providing such visualizations may utilize a recursive cycle function to group nodes having the same name, one node at a time, to produce a Sankey-like diagram.

In at least some embodiments, an issue may arise in which edge counts (e.g., relating to connections between nodes) are inaccurate. At a given node, the count at an input edge may be calculated as the total number of all output edges and all output edges of the child nodes, plus one. When the cycle function is executed, and nodes with the same name are merged, the context of only one node may be displayed in a user interface, rather than the context of all nodes that were combined. Accordingly, for a selected node for which counts are to be displayed, only the counts for that one selected node may be displayed, rather than a combined total count of all nodes that were merged into the node. To remedy the inaccurate count information, the contact center system 100 may execute a method 1600 described below.

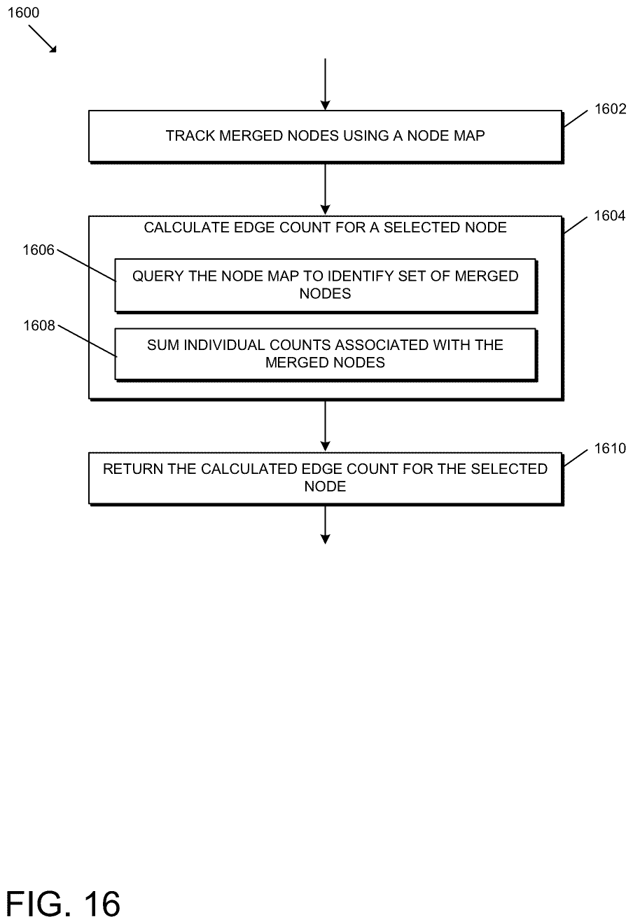

Referring now to FIG. 16, in use, a computing system (e.g., the contact center system 100, one or more computing devices 200, and/or other computing devices described herein) may execute a method 1600 for calculating accurate edge counts for a node associated with a trie data structure. It should be appreciated that the particular blocks of the method 1600 are illustrated by way of example, and such blocks may be combined or divided, added or removed, and/or reordered in whole or in part depending on the particular embodiment, unless stated to the contrary.

The illustrative method 1600 begins with block 1602 in which the computing system tracks merged nodes using a node map (e.g., a data structure that indicates nodes and relationships between the nodes). Further, in block 1604, the computing system calculates an edge count for a selected node (e.g., in a user interface). In doing so, in block 1606, the computing system may query the node map from block 1602 to identify a set of merged nodes that were merged into the selected node. Further, in block 1608, the computing system sums individual counts associated with those merged nodes that were identified in block 1606. In block 1610, the computing system returns (e.g., to a process providing a visualization of the corresponding trie data structure, such as the combined organization tie data structure), the calculated edge count for the selected node.

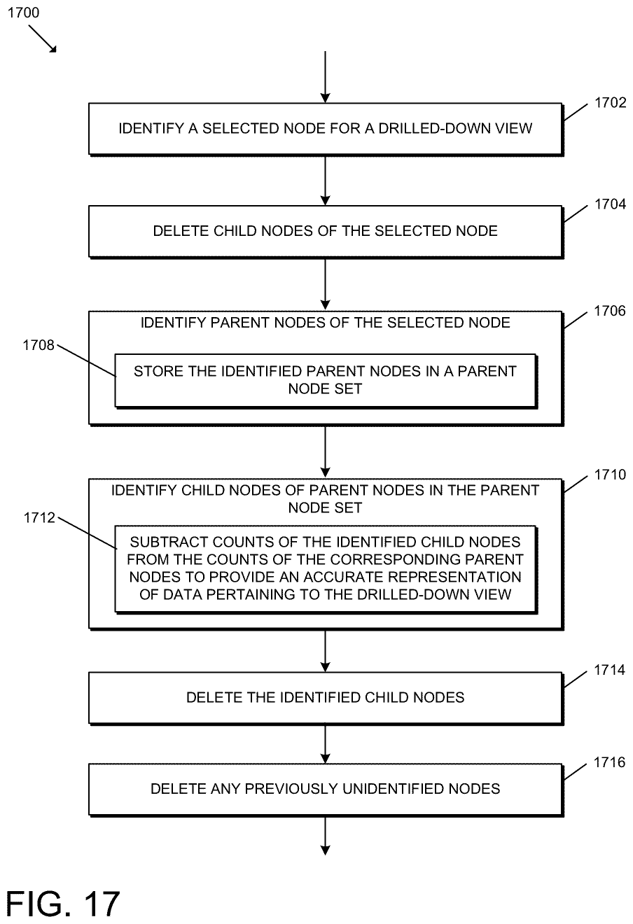

Embodiments of the contact center system 100 may also perform specialized operations to support a drilled-down view of a portion of a trie data structure. That is, a visualization may enable a user to click on (e.g., select) a specific node for a drilled-down view (e.g., a focused view) pertaining to that node. In doing so, the contact center system 100 may show all paths leading up to the selected node (e.g., event). Further, the contact center system 100 removes, from the visualization, all paths that do not lead to the selected node and all nodes (e.g., events) that occur after the selected node. A problem related to the above functionality is that, while drilling down to a selected node, the edge counts for nodes may be recalculated using the cycle function referenced above, using a corresponding subset of data. However, given that the cycle function does not account for all nodes that were merged into the selected node, the contact center system 100 may calculate inaccurate count information for the selected node. As described with reference to FIG. 17, the contact center system 100 may perform a method 1700 to update the counts of edges in the drilled-down view. To accurately calculate the counts for the drilled-down view, the contact center system 100 may utilize the node map described above with reference to the method 1600. Although the blocks 1602-1610 are described in a relatively serial manner, it should be appreciated that various blocks of the method 1600 may be performed in parallel in some embodiments.

Referring now to FIG. 17, in use, a computing system (e.g., the contact center system 100, one or more computing devices 200, and/or other computing devices described herein) may execute a method 1700 for calculating accurate count data for a drilled-down view in a visualization associated with a trie data structure. It should be appreciated that the particular blocks of the method 1700 are illustrated by way of example, and such blocks may be combined or divided, added or removed, and/or reordered in whole or in part depending on the particular embodiment, unless stated to the contrary.

The illustrative method 1700 begins with block 1702 in which the computing system identifies a selected node for a drilled-down view. Further, the computing system deletes child nodes of the selected node, in block 1704. That is, the computing system removes, from the visualization, any data pertaining to child nodes of the selected node. Continuing the method 1700, in block 1706, the computing system identifies parent nodes (ancestors) of the selected node. In doing so, the computing system stores the identified parent nodes (ancestors) in a parent node set. Further, in block 1710, the computing system identifies child nodes of the parent nodes in the parent node set from block 1706. In block 1712, the computing system subtracts counts of the identified child nodes from the counts of the corresponding parent nodes. Doing so provides an accurate representation of the subset of data pertaining to the drilled-down view. Further, the computing system deletes the identified child nodes, in block 1714. That is, the computing system removes from the visualization, any representation of the child nodes. Additionally, in block 1716, the computing system deletes (e.g., removes from the visualization) any previously unidentified nodes that do not pertain to the selected node (e.g., that do not lead to the selected node). Although the blocks 1702-1716 are described in a relatively serial manner, it should be appreciated that various blocks of the method 1700 may be performed in parallel in some embodiments.

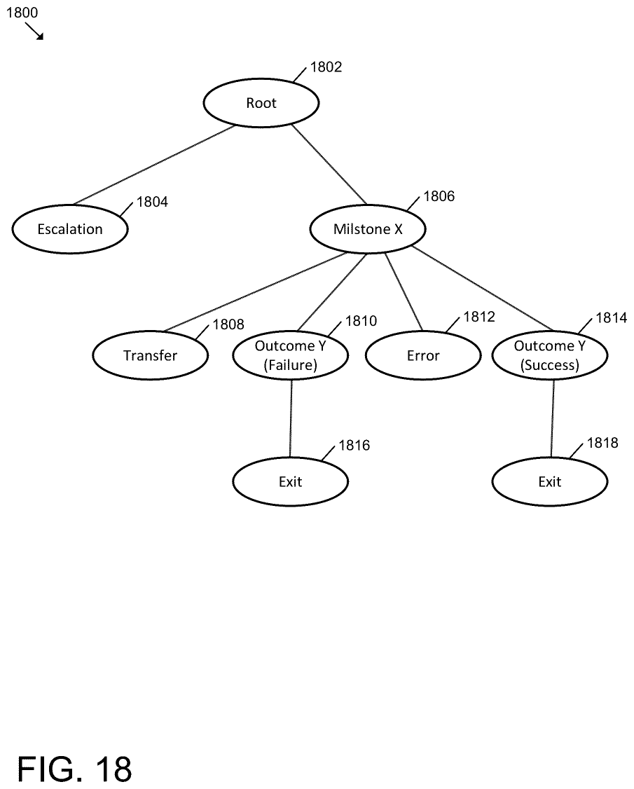

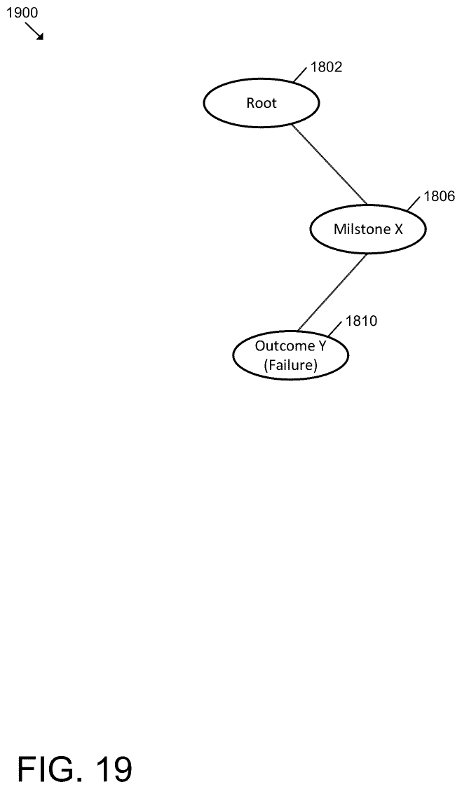

Referring to FIGS. 18 and 19, a trie data structure 1800 in a first state, prior to the production of a drilled-down view, includes nodes 1802, 1804, 1806, 1808, 1810, 1812, 1814, 1816, 1818. In response to a user selecting a particular node, which in the present example is the node 1810, the computing system updates the state of the trie data structure 1800 as illustrated in FIG. 19 to support a drilled-down view. As indicated, only nodes 1802, 1806, 1810 along the path to the selected node 1810 are represented in the updated state, as each of the nodes 1804, 1808, 1812, 1814, 1816, 1818 falls within one of the sets of nodes to be removed from the visualization in accordance with the method 1700. That is, the node 1816 is removed for being a child of the selected node 1810. Further, the nodes 1804, 1808, 1812, 1814 are removed for being children of the set of parent nodes and that are not along the path to the selected node 1810.

What is claimed is:

1. A method for providing efficient trie data structure processing, the method comprising:
splitting, by a computing system and based on organization identifiers and sequence identifiers, a data frame indicative of a set of events associated with customer interactions with automated agents of a contact center to produce a set of multiple partitions;
producing, by the computing system, a set of multiple trie data structures, including generating a trie data structure for each partition, wherein each trie data structure represents aggregate counts of a corresponding subset of event sequences associated with a corresponding organization;
merging, by the computing system, multiple trie data structures of the set of trie data structures to produce a combined organization trie data structure; and
storing, by the computing system, the combined organization trie data structure to enable generation of a visualization of the combined organization trie data structure.

2. The method of claim 1, further comprising:
assigning, by the computing system, each partition to a separate execution unit for concurrent processing.

3. The method of claim 1, further comprising:
performing, by the computing system, analytics on the combined organization trie data structure including filtering the combined organization trie data structure as a function of a path category indicative of a type of event that occurred during the customer interactions with the automated agents of the contact center.

4. The method of claim 1, wherein merging the multiple trie data structures comprises:
identifying a set of unique organization identifiers associated with the multiple trie data structures;
repartitioning the data frame based on the organization identifiers; and
merging trie data structures that are associated with a shared organization identifier.

5. The method of claim 1, wherein merging the multiple trie data structures comprises:
initializing an empty base trie data structure;
reading multiple trie data structures of the set from storage as subtrie data structures; and
merging each subtrie data structure into the base trie data structure.

6. The method of claim 5, wherein merging each subtrie data structure into the base trie data structure comprises, for each subtrie data structure:
sorting node paths by distance from a root in ascending order; and
combining a subtrie node with a base trie node in response to a determination that a node path exists in the base trie data structure or adding the subtrie node to the base trie data structure as a new node in response to a determination that the node path does not exist in the base trie data structure.

7. The method of claim 1, further comprising:
tracking, by the computing system, merged nodes of the combined organization trie data structure using a node map; and
calculating, by the computing system, an edge count for a selected node represented in the node map, including querying the node map to identify the set of merged nodes and summing individual counts associated with the merged nodes.

8. The method of claim 1, further comprising:
identifying, by the computing system, a selected node of the combined organization trie data structure for a drilled-down view in the visualization;
identifying, by the computing system, a child node set of one or more child nodes of the selected node; and
deleting, by the computing system, the child node set from the visualization.

9. The method of claim 8, further comprising:
identifying a parent node set of one or more parent nodes of the selected node;
identifying a set of one or more child nodes of the parent node set;
subtracting counts of the identified child nodes from counts of corresponding parent nodes in the parent node set to provide an accurate representation of count data pertaining to the drilled-down view; and
deleting the identified child nodes of the parent node set in the drilled-down view.

10. A system for providing efficient trie data structure processing, the system comprising:
at least one processor; and
at least one memory comprising a plurality of instructions stored thereon that, in response to execution by the at least one processor, causes the system to:
split, based on organization identifiers and sequence identifiers, a data frame indicative of a set of events associated with customer interactions with automated agents of a contact center to produce a set of multiple partitions;
produce a set of multiple trie data structures, including generating a trie data structure for each partition, wherein each trie data structure represents aggregate counts of a corresponding subset of event sequences associated with a corresponding organization;
merge multiple trie data structures of the set of trie data structures to produce a combined organization trie data structure; and
store the combined organization trie data structure to enable generation of a visualization of the combined organization trie data structure.

11. The system of claim 10, wherein the plurality of instructions further causes the system to assign each partition to a separate execution unit for concurrent processing.

12. The system of claim 10, wherein the plurality of instructions further causes the system to perform analytics on the combined organization trie data structure including filtering the combined organization trie data structure as a function of a path category indicative of a type of event that occurred during the customer interactions with the automated agents of the contact center.

13. The system of claim 10, wherein to merge the multiple trie data structures comprises to:
identify a set of unique organization identifiers associated with the multiple trie data structures;
repartition the data frame based on the organization identifiers; and
merge trie data structures that are associated with a shared organization identifier.

14. The system of claim 10, wherein to merge the multiple trie data structures comprises to:
initialize an empty base trie data structure;
read multiple trie data structures of the set from storage as subtrie data structures; and
merge each subtrie data structure into the base trie data structure.

15. The system of claim 14, wherein to merge each subtrie data structure into the base trie data structure comprises, for each subtrie data structure, to:
sort node paths by distance from a root in ascending order; and
combine a subtrie node with a base trie node in response to a determination that a node path exists in the base trie data structure or add the subtrie node to the base trie data structure as a new node in response to a determination that the node path does not exist in the base trie data structure.

16. The system of claim 10, wherein the plurality of instructions further causes the system to:
track merged nodes of the combined organization trie data structure using a node map; and
calculate an edge count for a selected node represented in the node map, including querying the node map to identify the set of merged nodes and summing individual counts associated with the merged nodes.

17. The system of claim 10, wherein the plurality of instructions further causes the system to:
identify a selected node of the combined organization trie data structure for a drilled-down view in the visualization;
identify a child node set of one or more child nodes of the selected node; and
delete the child node set from the visualization.

18. The system of claim 10, wherein the plurality of instructions further causes the system to:
identify a parent node set of one or more parent nodes of the selected node;
identify a set of one or more child nodes of the parent node set;
subtract counts of the identified child nodes from counts of corresponding parent nodes in the parent node set to provide an accurate representation of count data pertaining to the drilled-down view; and
delete the identified child nodes of the parent node set in the drilled-down view.

19. One or more non-transitory machine-readable storage media comprising a plurality of instructions stored thereon that, in response to execution by a computing system, causes the computing system to:
split, based on organization identifiers and sequence identifiers, a data frame indicative of a set of events associated with customer interactions with automated agents of a contact center to produce a set of multiple partitions;
produce a set of multiple trie data structures, including generating a trie data structure for each partition, wherein each trie data structure represents aggregate counts of a corresponding subset of event sequences associated with a corresponding organization;
merge multiple trie data structures of the set of trie data structures to produce a combined organization trie data structure; and
store the combined organization trie data structure to enable generation of a visualization of the combined organization trie data structure.

20. The one or more non-transitory machine-readable storage media of claim 19, wherein the plurality of instructions further causes the computing system to assign each partition to a separate execution unit for concurrent processing.
